(19) United States
(12) Patent Application Publication
(10) Pub. No.: US 2026/0192344 A1
(43) Pub. Date: Jul. 9, 2026

(54) Rotatable Dust Removal Device

(71) Applicant: LIBAIYI CO., LTD., Tainan City (TW)

(72) Inventors: Wei-Ping Chang, Tainan City (TW); Tai-Chang Wu, Tainan City (TW)

(21) Appl. No.: 19/399,674

(22) Filed: Nov. 25, 2025

(30) Foreign Application Priority Data
Jan. 9, 2025 (TW) 114100953
Jan. 9, 2025 (TW) 114200356

(51) Int. Cl. B08B 15/02

(52) U.S. Cl. CPC B08B 15/02; B08B 2215/003

(57) ABSTRACT

A rotatable dust removal device contains an outer housing and at least one cleaner head. The outer housing includes at least two inflow orifices. The cleaner head includes a positioning base, a central shaft, a rotatable connection seat, a body, and multiple air nozzles. The positioning base introduces rotational airflow through air guiding channels into swirling channels formed in the rotatable connection seat. The body defines a dust collection channel and includes through holes connected to the air nozzles. When airflow is ejected from the swirling channels, it generates a rotational torque that drives the rotatable connection seat, the body, and the air nozzles to rotate synchronously around the central shaft, enabling efficient dust removal from a workpiece.

### TECHNICAL FIELD

The present invention relates to a dust removal device, and more particularly to a rotatable dust removal device in which the airflow passages for dust-removal airflow and rotational airflow are independently operated in multiple modes.

### BACKGROUND

Currently, cleaning and dust removal systems used for thin-type roll materials (such as optical films, solar panels, glass substrates, and PCB/FPCB boards) typically employ non-contact dry-type cleaning devices due to the sensitive and fragile nature of the surface of these roll materials. The cleaning principle generally involves a specially designed cleaner head (also referred to as a “dust removal head”) which generates a high-speed oscillating air knife flow at its center. This oscillating airflow induces vibration on the surface of the roll material, thereby dislodging dust particles adhered to the surface. Additionally, negative pressure ports are arranged on both sides of the cleaner head, which are connected to an external vacuum suction device to form a negative pressure chamber. This creates a vacuum effect that removes the detached dust, thereby achieving effective dust removal from the surface of the roll material.

Taiwan Patent No. I717077 discloses a non-contact cleaning device, in which a dust-removal box having a dust-removal space is mounted over a cleaner head used to blow air onto roll materials. A negative pressure box, configured for accommodating a workpiece to be cleaned, is connected to the bottom of the dust-removal box. The negative pressure box and the surface of a conveying table together define a negative pressure space. By incorporating the additional negative pressure box and dust-removal box, the effective suction range for removing dust particles from the surface of the workpiece is enlarged.

Taiwan Patent No. I737415 further discloses a rotary-type cleaner head structure. A rotating member is sleeved onto a distal end of a spray rod, and two spray orifices are formed at the distal end of the spray rod. The rotating member includes two L-shaped rotary flow channels that respectively correspond to and communicate with the spray orifices. As a result, the ends of the rotary flow channels are configured to form two side outlets and two lower outlets located at a bottom surface of the rotating member. When airflow is sprayed from the spray orifices at the center of the cleaner head, the airflow is also ejected through the two lower outlets. Simultaneously, airflow ejected from the side outlets generates a reverse thrust cutting force that drives the rotating member to rotate at the distal end of the spray rod, thereby producing a rotary jet airflow and increasing the dust-removal coverage of the cleaner head.

However, the above-mentioned cleaner head structure still has the following unresolved issues:

Since the central spray orifice of the cleaner head directly communicates with the side outlets and the lower outlets of the rotating member (i.e., sharing the same air source), the airflow paths differ in length. Conventionally, the airflow pressure at the central spray orifice is higher than that at the side outlets. As a result, the rotating member may be restricted from rotating on the spray rod, or may only rotate slightly at the initial stage of airflow injection and then come to a halt.

The rotating member solely relies on a single air pressure source to generate the rotary jet airflow. Therefore, it cannot appropriately adjust its rotational speed or jet pressure according to the surface contour of the web material. As a consequence, this type of rotary cleaner head is currently limited to use in small-scale dust-removal systems and is not suitable for cleaning larger-sized web materials.

Because the rotating member is externally mounted to the distal end of the spray rod, it is not possible to timely vary the number of spray orifices or the jetting angles. This significantly compromises the dust-removal efficiency of the entire cleaner head.

Due to the cleaner head is completely covered by a suction hood and the dust-removal box, the operator is unable to determine whether the rotating member is still rotating or has stopped. Frequent shutdowns are required for inspection, which makes operation inconvenient.

The present invention has arisen to mitigate and/or obviate the afore-described disadvantages.

### SUMMARY

The primary aspect of the present invention is to provide a rotatable dust removal device in which the dust-removal airflow and the rotational airflow for driving the cleaner head are arranged as separate and independent airflow passages. This configuration not only prevents mutual interference between the two airflow paths, but also allows for independent control of their respective pressures, thereby enabling flexible adjustment of the spraying range, airflow pressure, and rotational speed of the cleaner head based on varying processing conditions.

The rotatable dust removal device of the present invention enables independent control of the cleaner head’s rotation via a separately regulated air pressure source, and is combined with various types of air nozzles to achieve different spraying ranges and effects. Therefore, the rotatable dust removal device is adaptable for dust removal systems of various sizes and configurations.

The rotatable dust removal device of the present invention includes a light-transmitting plate disposed on the outer housing, thus allowing an operator to directly observe whether the cleaner head is rotating or has stopped through the light-transmitting plate, thus enhancing operational convenience.

To obtain above-mentioned aspects, the rotatable dust removal device proposed by the present invention is configured to perform a cleaning operation on a workpiece and contains an outer housing and at least one cleaner head disposed within the outer housing. The outer housing includes a receiving space defined by a surrounding wall and opened at a bottom of the outer housing, and at least two inflow orifices and at least one outflow orifice located at a top of the surrounding wall. The cleaner head contains a positioning base, a central shaft, a rotatable connection seat, a body, and a plurality of air nozzles. The positioning base includes at least one vent port communicating with one of the at least two inflow orifices, two injection ports respectively communicating with the other of the at least two inflow orifices, and two air guiding channels respectively communicating with the two injection ports. The central shaft includes an axial hole extending along an axis and communicating with the vent port. The rotatable connection seat is rotatably mounted on the central shaft and disposed below the positioning base, the rotatable connection seat including a through hole through which the central shaft extends, and two swirling channels respectively communicating with the two air guiding channels. Each swirling channel has an outlet. The body is connected to the rotatable connection seat and rotatably mounted at a bottom of the central shaft. The body cooperates with the surrounding wall of the outer housing to define a dust collection channel, which communicates with the outflow orifice. The body includes a central hole coaxially aligned with the axis, a plurality of through holes formed at a bottom of the body and respectively communicating with the central hole, and an airflow passage formed by the axial hole and the through holes. The plurality of air nozzles are respectively connected to the through holes of the body, and each injector includes a spray tube and a nozzle, the nozzle having at least one spray orifice in communication with the dust collection channel. Accordingly, when the rotational airflow is pumped from the air guiding channels into the swirling channels and ejected from the respective outlets, a rotational torque is generated to drive the rotatable connection seat, the body, and the air nozzles to synchronously rotate about the central shaft.

### BRIEF DESCRIPTION OF THE DRAWINGS

FIG. 1 is a perspective view showing the exploded components of a rotatable dust removal device according to a first embodiment of the present invention.

FIG. 2 is a perspective view showing the assembly of a cleaner head of the rotatable dust removal device according to the first embodiment of the present invention.

FIG. 3 is a perspective view showing the exploded components of the cleaner head shown in FIG. 2 according to the first embodiment of the present invention.

FIG. 4 is a cross sectional view illustrating a usage state, showing the rotational airflow introduced from the injection port of the positioning base, sequentially passing through the air guiding seat and the swirling channels of the rotatable connection seat, and being ejected from two outlets to drive the cleaner head to rotate according to the first embodiment of the present invention.

FIG. 5 is a cross sectional view showing the operation of the rotatable dust removal device according to the first embodiment of the present invention.

FIG. 6 is another cross sectional view showing the operation of the rotatable dust removal device according to the first embodiment of the present invention.

FIG. 7 is a top plan view illustrating the rotational airflow entering the swirling channels of the rotatable connection seat and being ejected from the two outlets to generate a rotational torque for driving the cleaner head to rotate according to the first embodiment of the present invention.

FIG. 8 is a top plan view illustrating a first driving mode, in which the rotational airflow is sprayed onto the wing plates to cause the cleaner head to rotate in a clockwise direction according to the first embodiment of the present invention.

FIG. 9 is a top plan view illustrating a second driving mode, in which the rotational airflow is sprayed onto the wing plates to cause the cleaner head to rotate in a counterclockwise direction according to the first embodiment of the present invention.

FIG. 10 is a top view showing the assembly of a rotatable dust removal device according to a second embodiment of the present invention.

FIG. 11 is a perspective view showing the exploded components of the positioning base, multiple locking elements, and the rotatable connection seat in a disassembled state, in which the cleaner head of the rotatable dust removal device is configured in a non-rotating mode according to the second embodiment of the present invention.

FIG. 12 is an assembled perspective view of FIG. 11, illustrating the cleaner head of the rotatable dust removal device in the non-rotating mode according to the second embodiment of the present invention.

### DETAILED DESCRIPTION

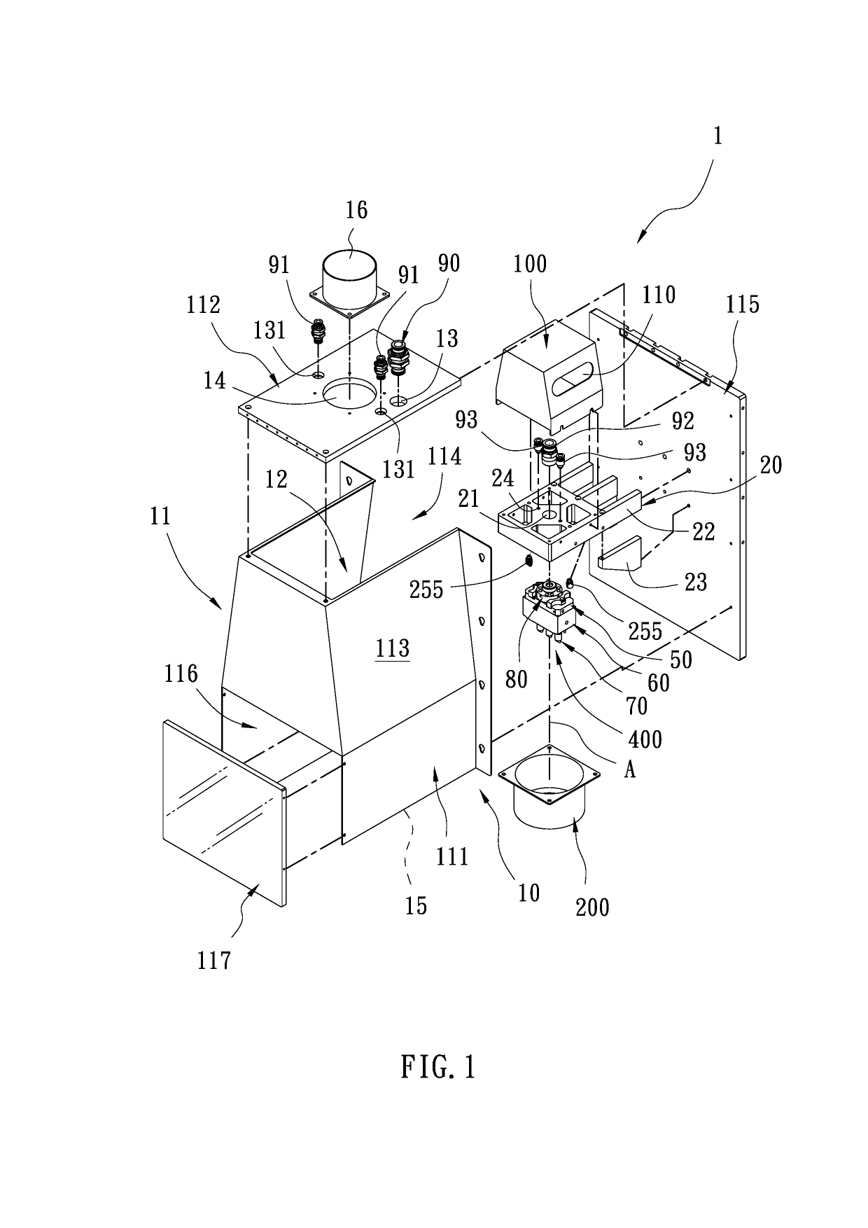

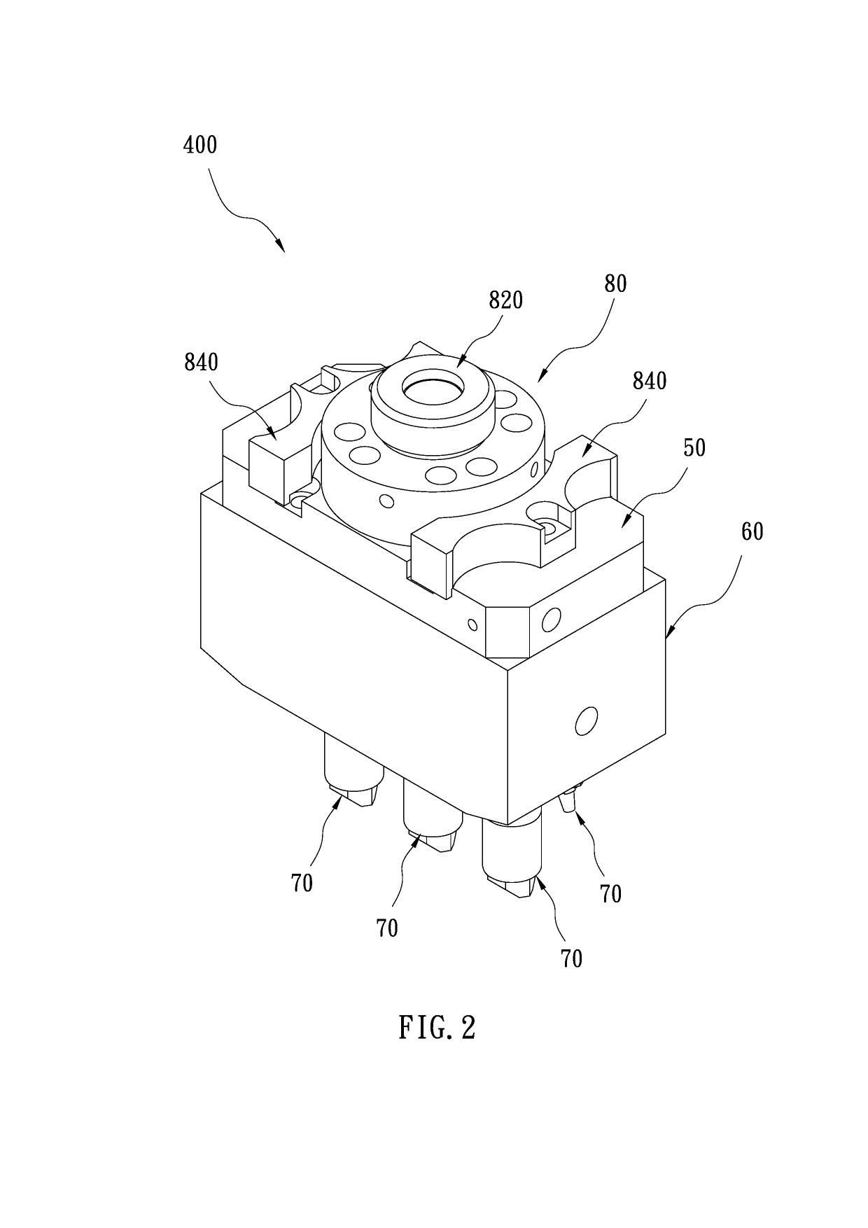

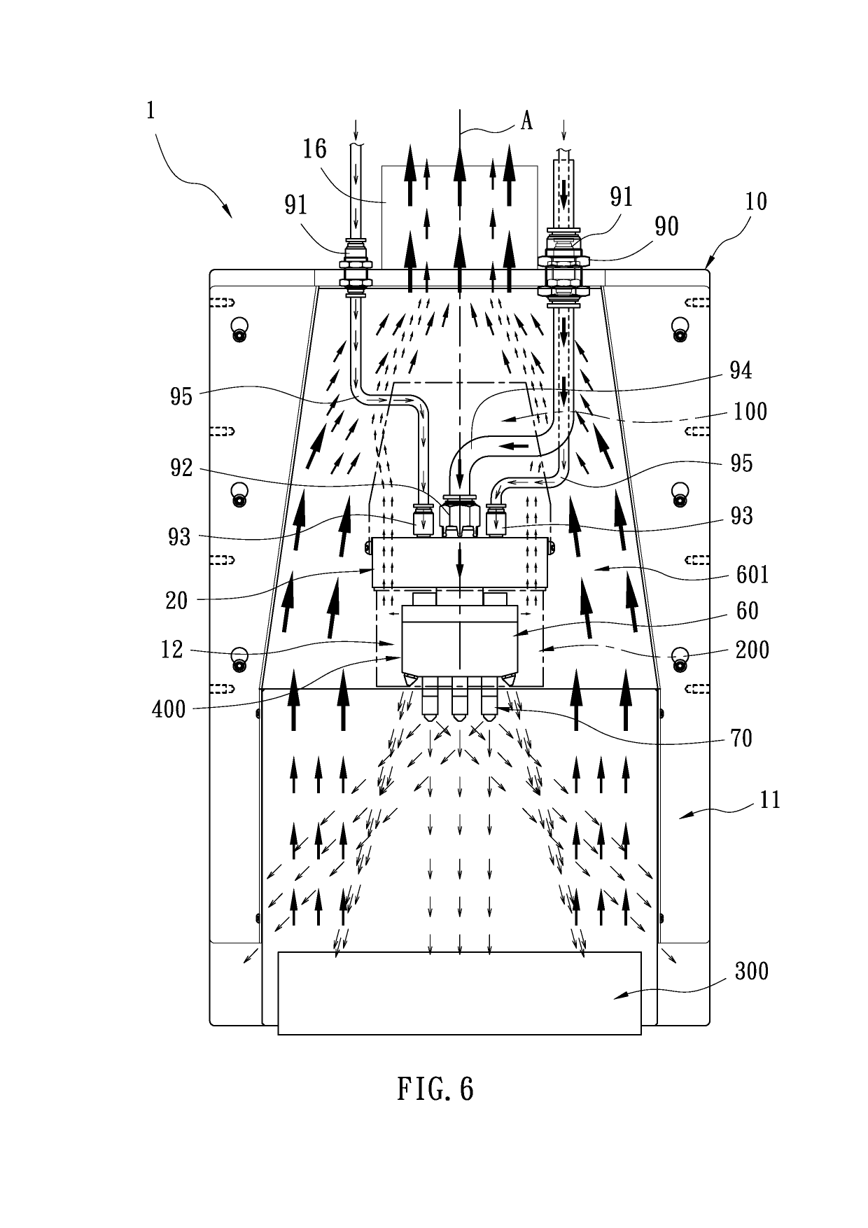

With reference to FIG. 6, a rotatable dust removal device 1 according to a first embodiment of the present invention is configured to perform continuous air-spraying and vibration-based cleaning on a surface of a workpiece 300. As shown in FIGS. 1 to 3, the dust removal device 1 comprises an outer housing 10, an inner cover 100, a collection hood 200, and a cleaner head 400.

The outer housing 10 comprises a receiving space 12 defined by a surrounding wall 11 and opened at a bottom thereof, at least two inflow orifices 13, 131 and an outflow orifice 14 located on a top lid 112 of the surrounding wall 11, and an opening 15 that communicates with the receiving space 12 and corresponds to the workpiece 300. The surrounding wall 11 has a casing 111 which defines the receiving space 12, and the top lid 112 engaged to a top of the casing 111. The at least two inflow orifices 13, 131 and the outflow orifice 14 are defined on the top lid 112. Furthermore, the outer housing 10 further includes an exhaust tube 16 locked onto the top lid 112 and vertically aligned with the outflow orifice 14, for discharging oscillating airflow after the surface of the workpiece 300 is sprayed and cleaned. The casing 111 includes a conical hollow shell 113, a panel 115 engaged to a slot 114 on the side of the conical hollow shell 113, and a light-transmitting plate 117 locked to a bottom opening 116 of the conical hollow shell 113. Through the light-transmitting plate 117, an operator directly observes the cleaner head 400 and the workpiece 300 from outside, thus allowing monitoring of a working status of the body relative to the workpiece 300, for example, whether a body 60 of the cleaner head 400 is rotating or whether the workpiece 300 is positioned directly below the body 60. In this embodiment, three inflow orifices 13, 131 are provided on the top lid 112. Among them, the larger inflow orifice 13 serves as the airflow inlet for dust removal, and the two smaller inflow orifices 131 are configured to supply airflow for rotational driving.

The cleaner head 400 includes a positioning base 20, a central shaft 30, a bearing assembly 40, a rotatable connection seat 50, the body 60, a plurality of air nozzles 70, and an air guiding seat 80, wherein:

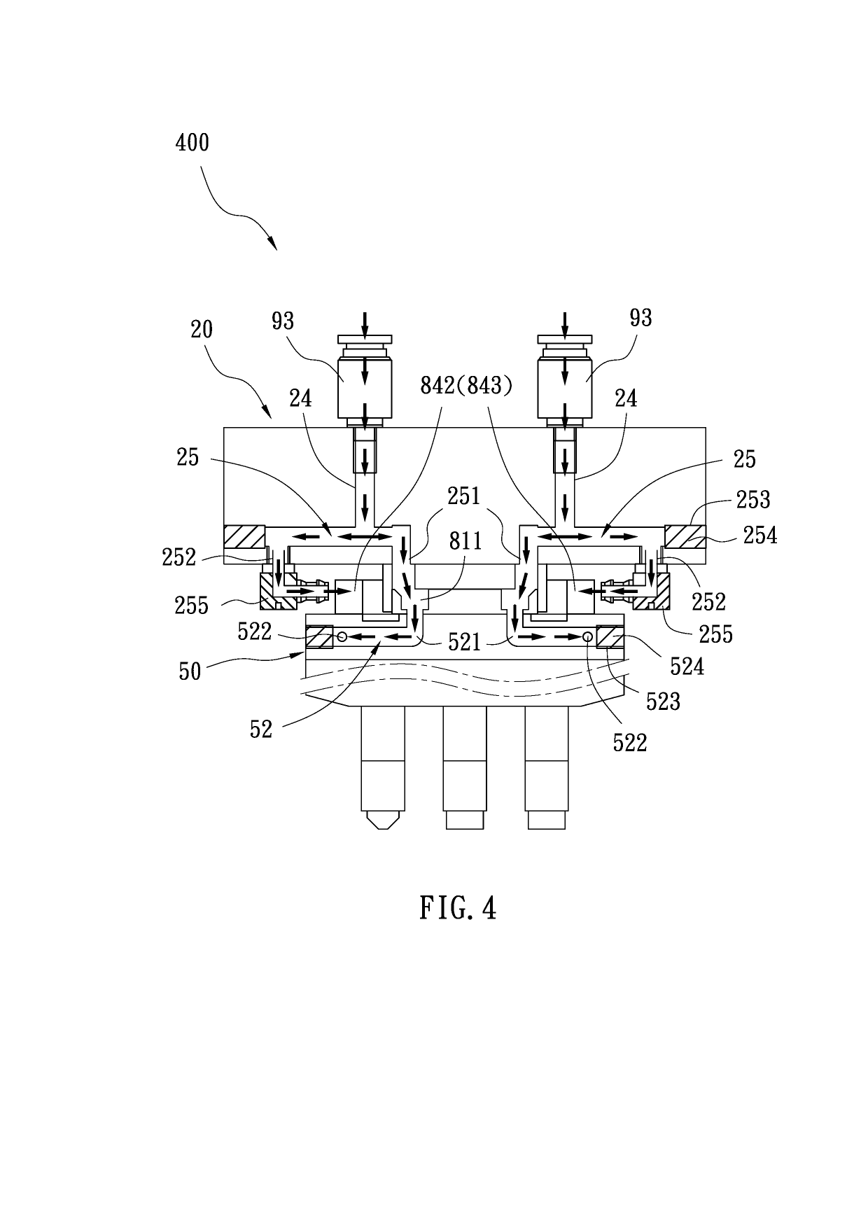

The positioning base 20 is disposed within the receiving space 12 and includes at least one vent port 21 that communicates with the larger inflow orifice 13 for introducing external airflow. In this embodiment, the positioning base 20 is secured to the panel 115 of the outer housing 10 by means of three elongated rib plates 22. To enhance the overall structural strength, the positioning base 20 further includes a reinforcement plate 23 connected between a bottom of the positioning base 20 and the panel 115 of the outer housing 10. Referring to FIG. 4, the positioning base 20 further includes two injection ports 24 which are parallel to the at least one vent port 21 and respectively communicating with the two smaller inflow orifices 131, two sets of diversion ports 251 and 252 arranged in an equally spaced and oppositely symmetrical manner on the bottom of the positioning base 20, and two air guiding channels 25 that communicate between the two injection ports 24 and the diversion ports 251 and 252. In this embodiment, each air guiding channel 25 extends vertically downward from the corresponding injection port 24, then branches horizontally to two sides, and finally turns downward again at two ends to connect with the diversion ports 251 and 252. The diversion port 252, which is adjacent to the horizontal portion of the air guiding channel 25, further extends laterally through a short side of the positioning base 20 to form a machining hole 253. Under normal operating conditions, a plug element 254 is inserted into the machining hole 253 to prevent lateral air leakage. Furthermore, each of the two diversion ports 252 is provided with a jet head 255.

The central shaft 30 is connected to the bottom of the positioning base 20 and includes an axial hole 31 extending along an axis A and communicating with the at least one vent port 21, a groove 32 located at a middle portion of the central shaft 30, a protruding ring 33 formed at a lower portion of the central shaft 30, and a plurality of openings 34 defined below the protruding ring 33. In addition, the central shaft 30 further includes a plurality of radial locking holes 35 formed at an upper portion thereof.

The bearing assembly 40 includes two bearing rings 41 and 42, a spacer 43 positioned between the two bearing rings 41 and 42, and a C-shaped retaining ring 44 disposed above the bearing ring 42. The bearing rings 41, 42 and the spacer 43 are fitted onto the central shaft 30, and the retaining ring 44 is engaged into the groove 32 of the central shaft 30, such that the bearing assembly 40 is secured between the groove 32 and the protruding ring 33 of the central shaft 30 to form a fixed configuration.

The rotatable connection seat 50 is disposed below the positioning base 20 and includes a through hole 51 through which the central shaft 30 is inserted. In this embodiment, the rotatable connection seat 50 is in a rectangular shape and further includes two swirling channels 52 formed around an outer wall of the through hole 51. Each swirling channel 52 has a winding configuration and includes an inlet 521 located at a top of the rotatable connection seat 50 and an outlet 522 positioned at a long side of the rotatable connection seat 50, such that the two outlets 522 are defined on two opposite outer walls of the rotatable connection seat 50 at a 180-degree angle relative to each other. Each swirling channel 52 is connected to a corresponding diversion port 251 of the positioning base 20 via the respective inlet 521, thus allowing the swirling channels 52 of the rotatable connection seat 50 to communicate with the air guiding channels 25 of the positioning base 20. One of the inlets 521 extends horizontally toward the corresponding outlet 522 and further penetrates a short side of the rotatable connection seat 50 to form a machining hole 523. Under normal conditions, a plug element 524 is inserted into the machining hole 523 to prevent air leakage. In this embodiment, the rotatable connection seat 50 includes two swirling channels 52, and their respective outlets 522 are arranged at a 180-degree angle on the rotatable connection seat 50. Additionally, the rotatable connection seat 50 further includes a plurality of locking holes 53 defined on the top thereof.

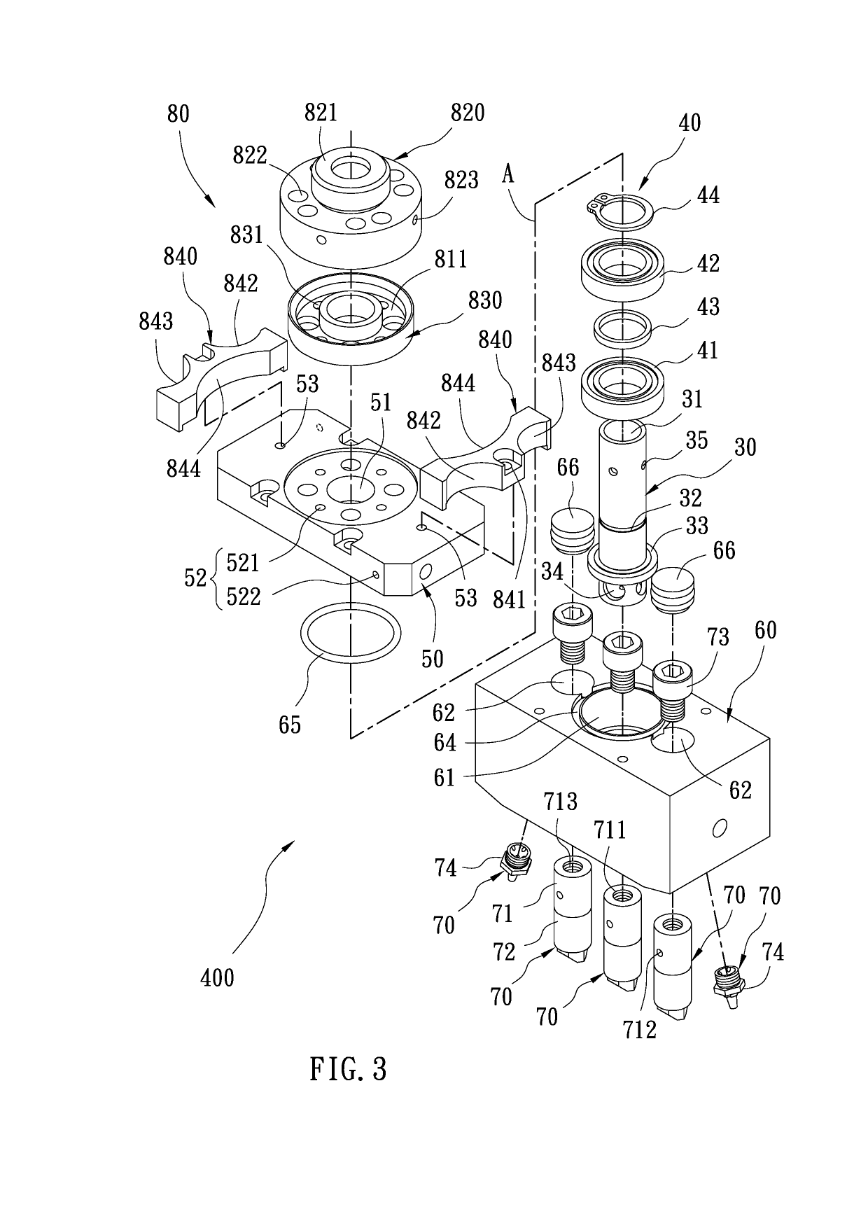

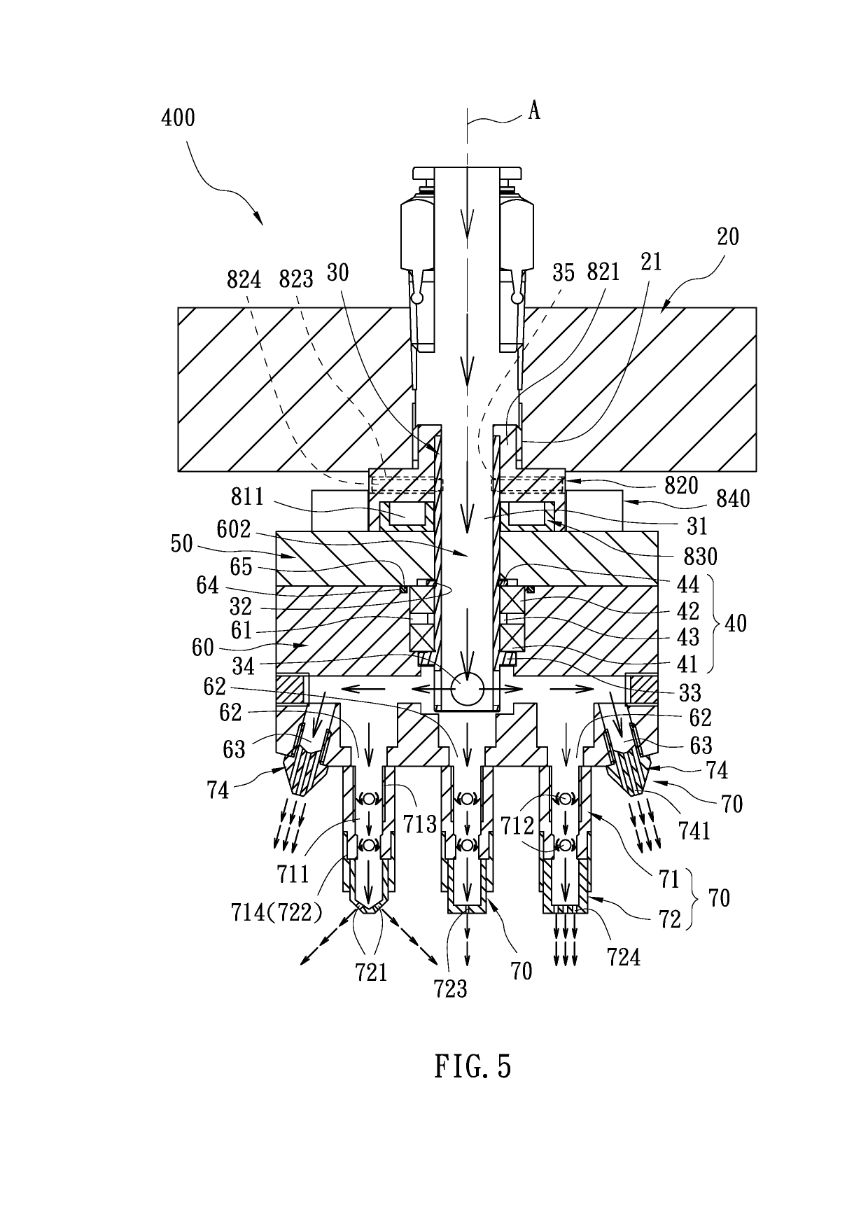

Referring to FIGS. 5 and 6, the body 60 is connected to the rotatable connection seat 50 and rotatably mounted at a bottom of the central shaft 30. The body 60 is positioned within the receiving space 12 and cooperates with the surrounding wall 11 of the outer housing 10 to define a dust collection channel 601, which is in communication with the outflow orifice 14. The body 60 includes a central hole 61 coaxially aligned with the axis A, a plurality of through holes 62 and 63 located at a bottom of the body 60 and communicating with the central hole 61, and an airflow passage 602 formed by the axial hole 31, the plurality of openings 34 and the through holes 62 and 63. A shallow groove 64 is formed along a top of the central hole 61, in which a gasket 65 is placed to prevent a gas leakage when the body 60 is connected with the rotatable connection seat 50. In this embodiment, the through holes 62 and 63 are arranged on the bottom of the body 60. Specifically, three vertically oriented through holes 62 are evenly spaced, and two additional through holes 63 located on two sides of the body 60 are outwardly inclined. As shown in FIG. 5, the two inclined through holes 63 are obliquely formed at an acute angle with respect to axis A, and the central through hole 62 is defined directly beneath the central hole 61 and communicates coaxially. Furthermore, the two through holes 62 located on opposite sides of the central hole 61 penetrate a top of the body 60 to facilitate machining. During a connection, the two through holes 62 are closed by two cap plugs 66 to achieve an airtight effect, as shown in FIG. 3.

As shown in FIGS. 3 and 5, the plurality of air nozzles 70 are respectively connected to the through holes 62 and 63 of the body 60. In this embodiment, five air nozzles 70 are provided, available in various configurations, including multi-stage type and single-tube type. The plurality of air nozzles 70 has a straight tubular appearance, with a total of three sets. Each air nozzle 70 is engaged to the through hole 62 by using a bolt 73. Each air nozzle 70 includes a spray tube 71 and a nozzle 72. The spray tube 71 includes a through passage 711 extending along the axis A and communicating with the through hole 62, at least one flow guide element 712 transversely disposed through the through passage 711, a mounting portion 713 at a top of the spray tube 71 for connecting with the bolt 73, and a connecting portion 714 at a bottom of the spray tube 71. A diameter of the through passage 711 is greater than a diameter of the flow guide element 712, and an outer wall of the flow guide element 712 is arcuate. The nozzle 72 includes at least one spray orifice 721 communicating with the through passage 711 and a mounting portion 722 coupled to the connecting portion 714 of the spray tube 71. The mounting portion 713 and connecting portion 714 of the spray tube 71 and the mounting portion 722 of the nozzle 72 are coupled with internal and external threads. A front end of the nozzle 72 is formed in a conical tip or a flat surface shape. The conical-tip nozzle 72 includes two angled spray orifices 721 that are inclined outward on two sides of the conical-tip nozzle 72, thus causing the airflow to spray laterally in opposite directions. The flat-surface nozzle 72 includes one or more coaxial spray orifices 723, 724 aligned with the axis A. The single-orifice nozzle 72 concentrates the airflow, and the multi-orifice nozzle 72 provides a wider spray range. The single-tube type air nozzles 70, of which two sets are provided, are engaged to the side through holes 63 of the body 60 in a screwing connection. A cross-section of the nozzle 74 of each single-tube injector 70 has an arrow-shaped profile. A front end of the nozzle 74 is conically tapered and is provided with a plurality of spray orifices 741 arranged to correspond with an inclined orientation of the through holes 63.

The air guiding seat 80 is connected between the positioning base 20 and the rotatable connection seat 50, and includes an upper shell 820 and a lower shell 830 which are connected together to define an air chamber 811, and two wing plates 840 which are mounted at equal intervals on the top of the rotatable connection seat 50.

The upper shell 820 includes a mounting portion 821 with external threads, eight upper guiding holes 822 arranged around an outer wall of the mounting portion 821, and several locking holes 823 corresponding to the locking holes 35 of the central shaft 30. The mounting portion 821 is screwed into the at least one vent port 21 of the positioning base 20, thus allowing the upper shell 820 to be engaged beneath the positioning base 20. This configuration enables the rotational airflow pumped through the two injection ports 24 and diverted via the diversion port 251 to flow into the air chamber 811 through the upper guiding holes 822, thus achieving a buffering and pressure-stabilizing effect. In addition, the upper shell 820 is secured to the central shaft 30 by means of multiple positioning pins 824, which are inserted through the locking holes 823 of the upper shell 820 into the locking holes 35 of the central shaft 30, thus forming a fixed connection between the upper shell 820 and the central shaft 30.

The lower shell 830 is fixed to the top of the rotatable connection seat 50 by bolts (not shown), and includes a plurality of lower guiding holes 831 corresponding to the upper guiding holes 822 of the upper shell 820. The plurality of lower guiding holes 831 extend through the inlets 521 of the rotatable connection seat 50 to communicate with the swirling channels 52.

Each of the two wing plates 840 is in a reversed curved bow shape, and includes a through hole 841 used for engaging to the locking holes 53 on the rotatable connection seat 50 by means of fixing elements, two concave arc portions 842 and 843 symmetrically disposed on two outer sides of the through hole 841, and an inner arc portion 844 located on an inner side of the through hole 841 and corresponding to the upper shell 820 and the lower shell 830. In addition, two mouths of two jet heads 255 are respectively aligned with the concave arc portions 842 and 843 at two diagonal positions of the two wing plates 840.

Furthermore, as shown in FIGS. 1 and 6, the rotatable dust removal device further comprises a plurality of air joints 90, 91, 92, and 93 for introducing external airflow, wherein the air joint 90 is connected to the larger inflow orifice 13 of the outer housing 10, and two air joints 91 are respectively connected to the smaller two inflow orifices 131. The air joint 92 is connected to the at least one vent port 21 of the positioning base 20, and two air joints 93 are respectively connected to the two injection ports 24 of the positioning base 20. A conduit 94 is connected between the two air joints 90 and 92, thus allowing the larger inflow orifice 13 of the outer housing 10 to communicate with the at least one vent port 21 of the positioning base 20 for introducing dust-removal airflow from the external source. Also, a plurality of conduits 95 are connected between the two air joints 91 and 93, thus communicating the smaller inflow orifices 131 of the outer housing 10 with the two injection ports 24 of the positioning base 20 for introducing rotational driving airflow from the external source.

The inner cover 100 is a hollow shell and is mounted above the at least one vent port 21 and the two injection ports 24 of the positioning base 20, thus forming an isolated state with an upper section of the dust collection channel 601. This configuration prevents interference between the dust-removal airflow and the suction airflow. Moreover, two side holes 110 are formed on a side of the inner cover 100 so as to allow the conduits 94 and 95 to pass through the side holes 110 and connect to the two air joints 92 and 93 on the positioning base 20.

The collection hood 200 is locked to the bottom of the positioning base 20 and surrounds the body 60. It effectively isolates the dust-removal airflow from the suction airflow, thus preventing mutual interference.

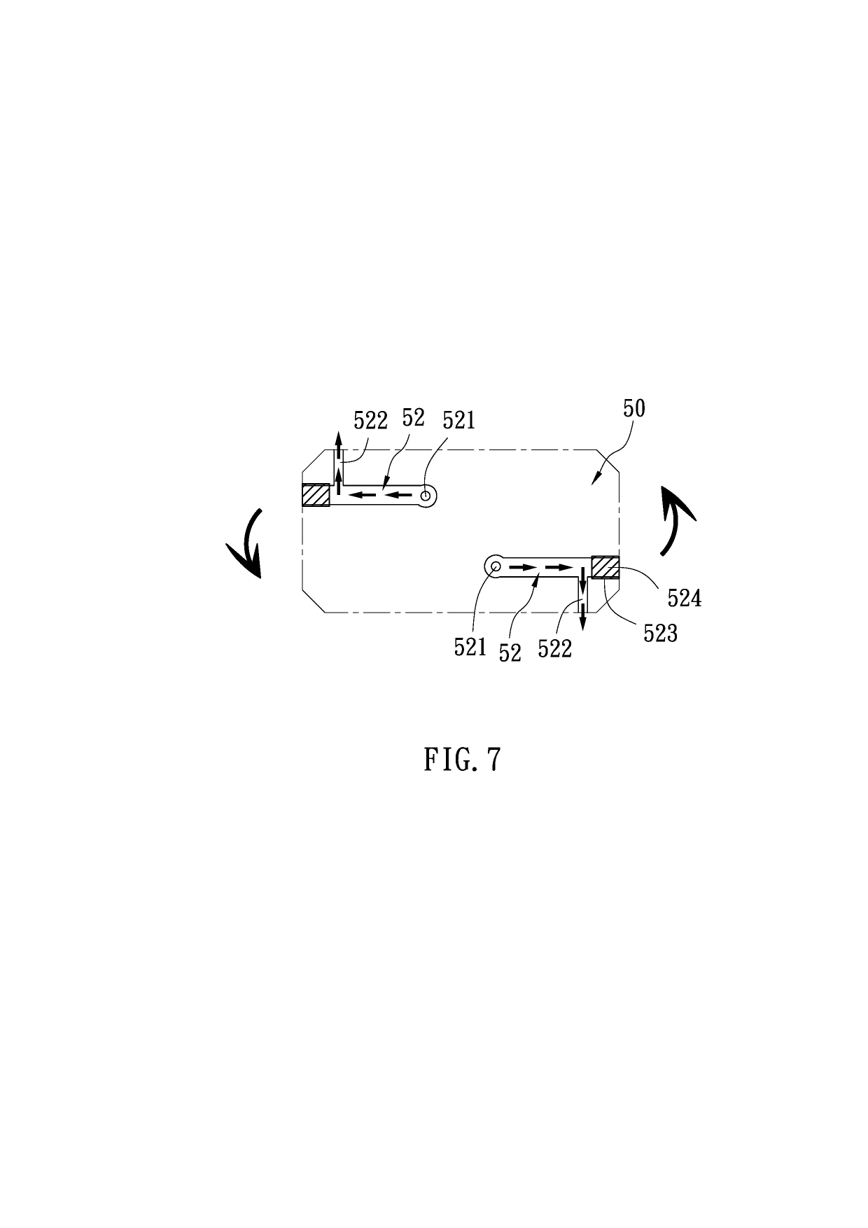

In this embodiment, the cleaner head 400 primarily operates in two rotational modes: internal-drive rotation and external-drive rotation. In the internal-drive mode, as shown in FIG. 4, operation begins by first ensuring that the two jet heads 255 are in a closed state (or alternatively, the diversion ports 252 are pre-closed using plugs, not shown). When external airflow is pumped into the injection port 24 of the positioning base 20, it first enters the air guiding channels 25, then sequentially passes through the diversion ports 251 and the upper guiding holes 822 of the upper shell 820, and flows into the air chamber 811 of the air guiding seat 80. The airflow inside the air chamber 811 then passes through the lower guiding holes 831 and enters the swirling channels 52 of the rotatable connection seat 50. Finally, the airflow is ejected from the outlets 522 at the ends of the swirling channels 52. Since the two outlets 522 are defined diametrically opposite to each other on the rotatable connection seat 50, two oppositely directed air streams are generated. The reaction force from the ejected air streams produces a rotational torque that drives the rotation of the rotatable connection seat 50 (as indicated by the arrows on two sides in FIG. 7). This causes the rotatable connection seat 50, the body 60, and the plurality of air nozzles 70 to rotate together around the central shaft 30, thus achieving the internal-drive rotational mode of the cleaner head 400, as illustrated in FIG. 7.

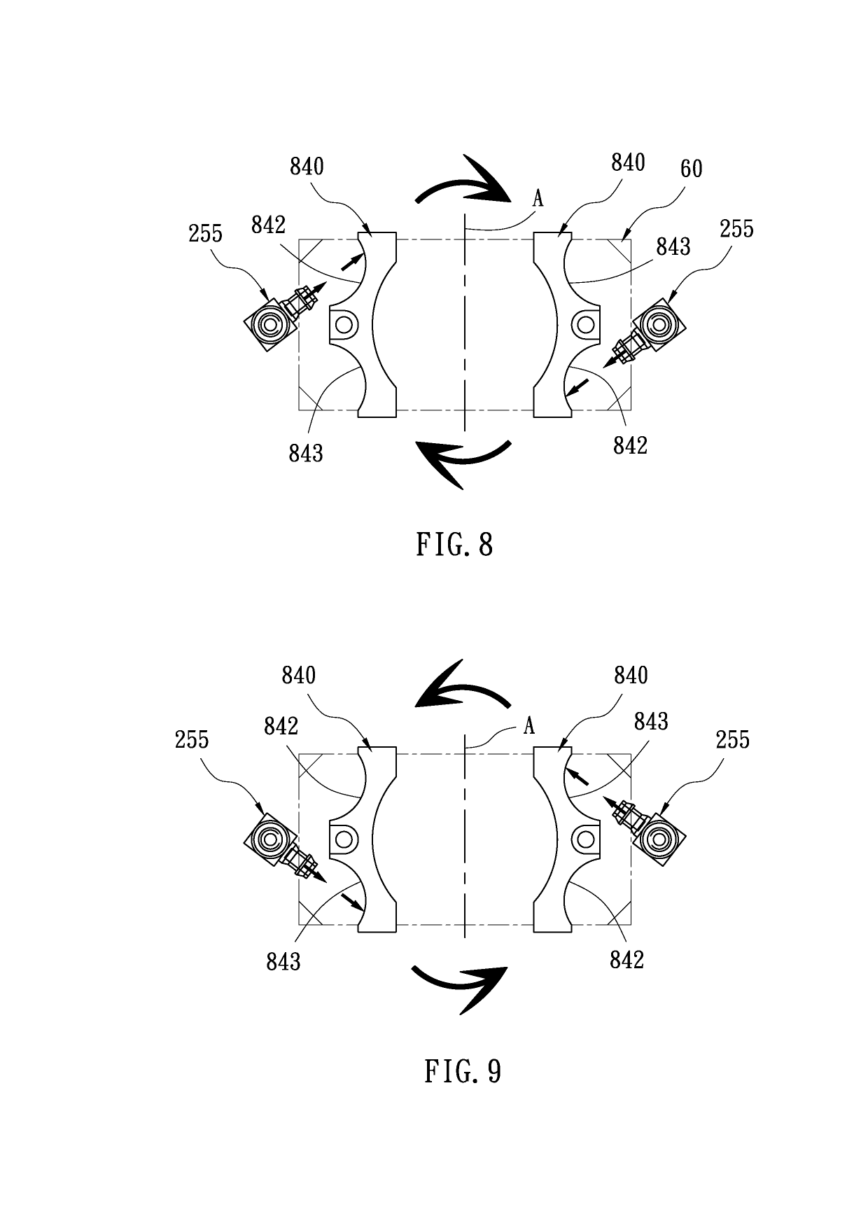

In the external-drive rotation mode of the cleaner head 400 of the present invention, the two outlets 522 on the rotatable connection seat 50 are pre-closed with respective plugs (not shown), while the two jet heads 255 mounted on the diversion ports 252 of the positioning base 20 are in an open state. Accordingly, when airflow is pumped through the air guiding channels 25 into the diversion ports 252, the air is sprayed outward from the two jet heads 255 toward the concave arc portions 842 or 843 of the two wing plates 840. The impingement of airflow against the two wing plates 840 causes them to rotate, thereby simultaneously driving the rotatable connection seat 50, the body 60, and the plurality of air nozzles 70 to rotate together around the central shaft 30. As illustrated in FIG. 8, when the airflow from the two jet heads 255 is directed at the concave arc portions 842 of the two wing plates 840, the rotatable connection seat 50, the body 60, and the plurality of air nozzles 70 rotate in a clockwise direction. Conversely, when the spraying direction of the two jet heads 255 is adjusted to align with the concave arc portions 843 of the two wing plates 840, the resulting airflow causes the rotatable connection seat 50, the body 60, and the plurality of air nozzles 70 to rotate in a counterclockwise direction, as shown in FIG. 9. Through the above structural configuration and operating method, the cleaner head 400 of the dust removal device 1 effectively achieves the external-drive rotational mode.

As shown in FIGS. 1, 5, and 6, during the dust-removal operation of the cleaner head 400, a vacuum pump (not shown) is externally connected to the exhaust pipe 16. When pressurized airflow is pumped in through the air joint 90, the airflow passes through the conduit 94 and the vent at least one port 21, and continues to flow into the airflow passage 602 of the body 60. The airflow is then injected into the previously described air nozzles 70 through the through holes 62 and 63, and passes through the through passage 711 of the spray tube 71 to impact the flow guide element 712. By applying the principle of Coandă Effect (also known as wall-attachment effect), the fluid deviates from its original flow direction and instead flows along the curved surface of the protruding object, which causes the surrounding fluid to be rapidly entrained, thus producing an accelerated jet effect (a similar structure can be found in Taiwan Patent No. I793842). Specifically, the airflow within the through passage 711 is sequentially accelerated along the smoothly curved outer surfaces of the two flow guide elements 712, and then continues toward the spray orifices 721, 723, 724, and 741 of the nozzle 72, where it is sprayed outward. By using various nozzle types and spray orifice configurations (721, 723, 724, 741), different spray effects are achieved. Therefore, through the airflow delivered from the body 60 and the multiple air nozzles 70, the present invention enables multi-stage flow acceleration, which improves the efficiency of blowing off dust from a workpiece. At the same time, as the rotatable connection seat 50 is driven by the rotating airflow, it synchronously rotates the body 60 and the multiple air nozzles 70, thus expanding the overall dust-removal coverage and effectiveness of the cleaner head 400. Finally, with the negative pressure suction generated from the exhaust pipe 16, the lifted dust particles are carried along the dust collection channel 601 and discharged outward along the direction of the axis A, thus achieving an effective dust removal and cleaning function.

Accordingly, the rotatable dust removal device of the present invention has the following advantages:

The airflow used for dust removal and the airflow used for rotational driving of the cleaner head 400 are configured as independent flow channels. First, this design prevents mutual interference between the two airflow paths. Second, it allows individual control of the respective air pressures, thus enabling flexible adjustment of the spraying range and the rotation speed of the cleaner head 400 according to the condition of different workpieces. As a result, the dust-removal operation becomes more versatile and adaptable to various application needs.

The rotatable dust removal device enables independent control of the cleaner head's rotation via a separately regulated air pressure source, and is further combined with various types of air nozzles 70 to achieve different dust-removal effects. Not only does this configuration allow multi-stage acceleration of airflow, but through the use of concentrated, diffused, and multi-orifice airflow spray types, it also enables effective adjustment of the spray angle and spray direction. This allows simultaneous discharge of airflow across a broader cleaning area and at a higher dust-removal speed. As a result, the system can efficiently remove dust from workpieces 300 featuring various grooves, gaps, or holes, thus obtaining a more ideal and optimized dust-removal effect.

By setting the light-transmitting plate 117, the operator is capable of directly observing whether the cleaner head 400 is rotating or has stopped through the light-transmitting plate 117 without stopping the machine, thus observing the working status of the dust removal operation at any time.

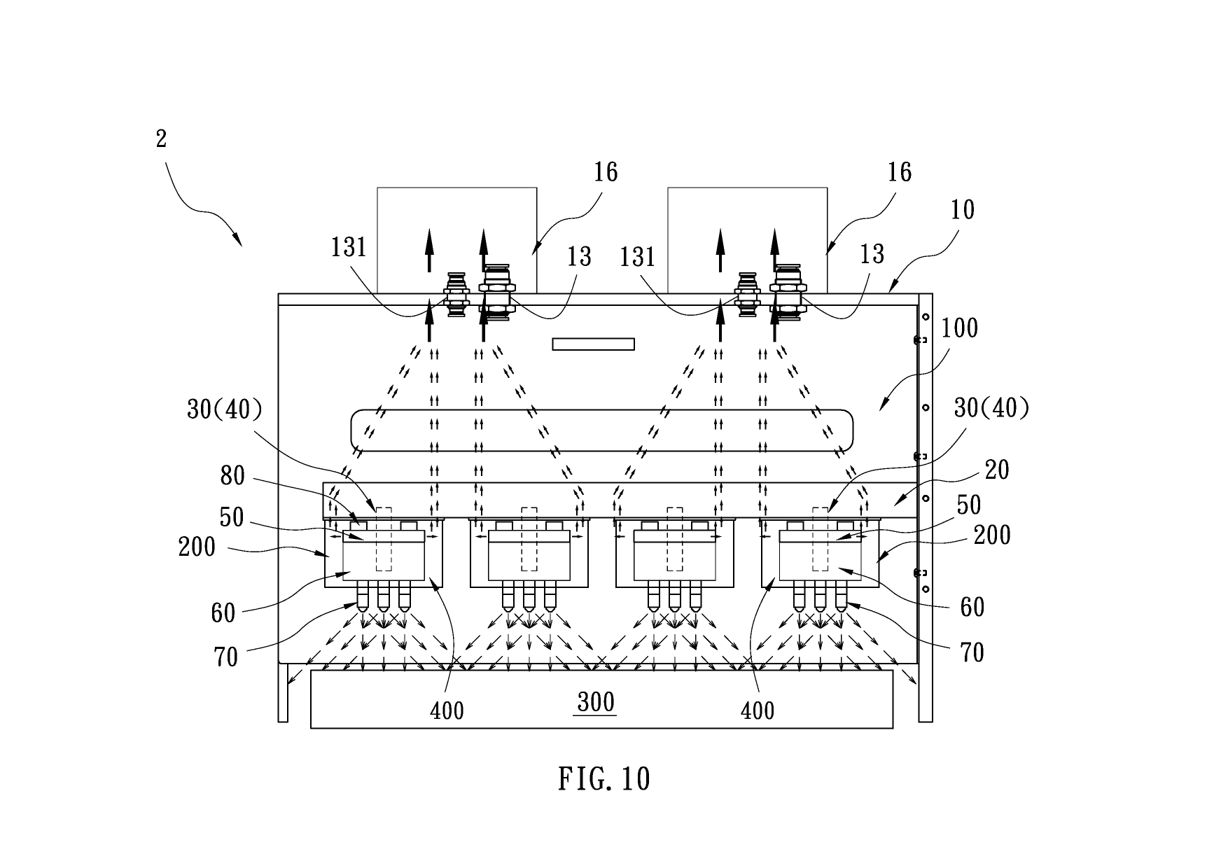

As shown in FIG. 10, a rotatable dust-removal device 2 according to a second embodiment of the present invention comprises an outer housing 10, an inner cover 100, a plurality of collection hoods 200, and multiple cleaner heads 400. Each cleaner head 400 includes a central shaft 30, a bearing assembly 40, a rotatable connection seat 50, a body 60, a plurality of air nozzles 70, and an air guiding seat 80. With reference to FIG. 1, these components are generally the same as those in the first embodiment. The primary difference lies in the fact that the multiple cleaner heads 400 are positioned and connected by using a single horizontally extended the positioning base 20. Each cleaner head 400 is individually paired with its own collection hood 200, and the air inlets 13 and 131 of the outer housing 10 are provided in the multiple cleaner heads 400 to accommodate multiple exhaust pipes 16. Each collection hood 200 is engaged to the bottom of the positioning base 20 and surrounds the outer wall of a corresponding body 60. This second embodiment is mainly designed to provide a multi-spray-head configuration, suitable for dust-removal and cleaning of larger-sized workpieces 300.

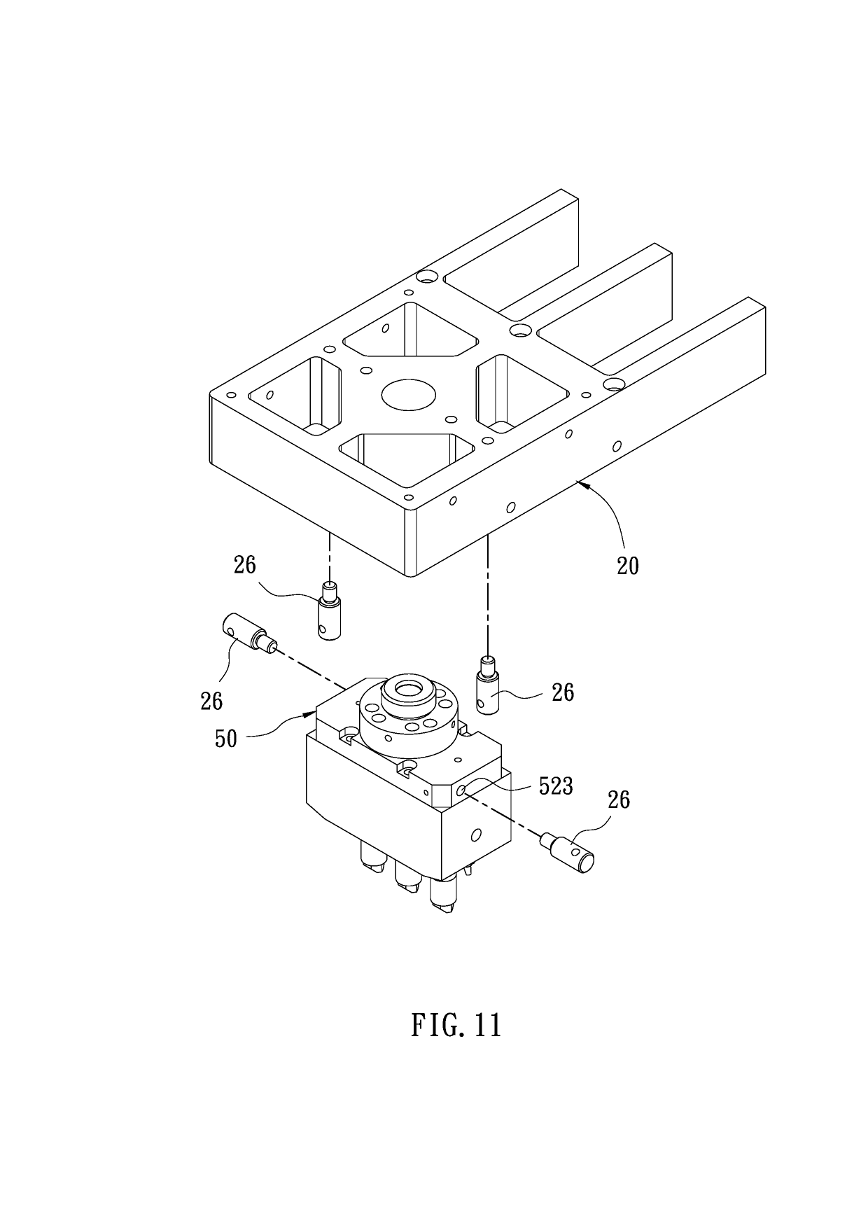

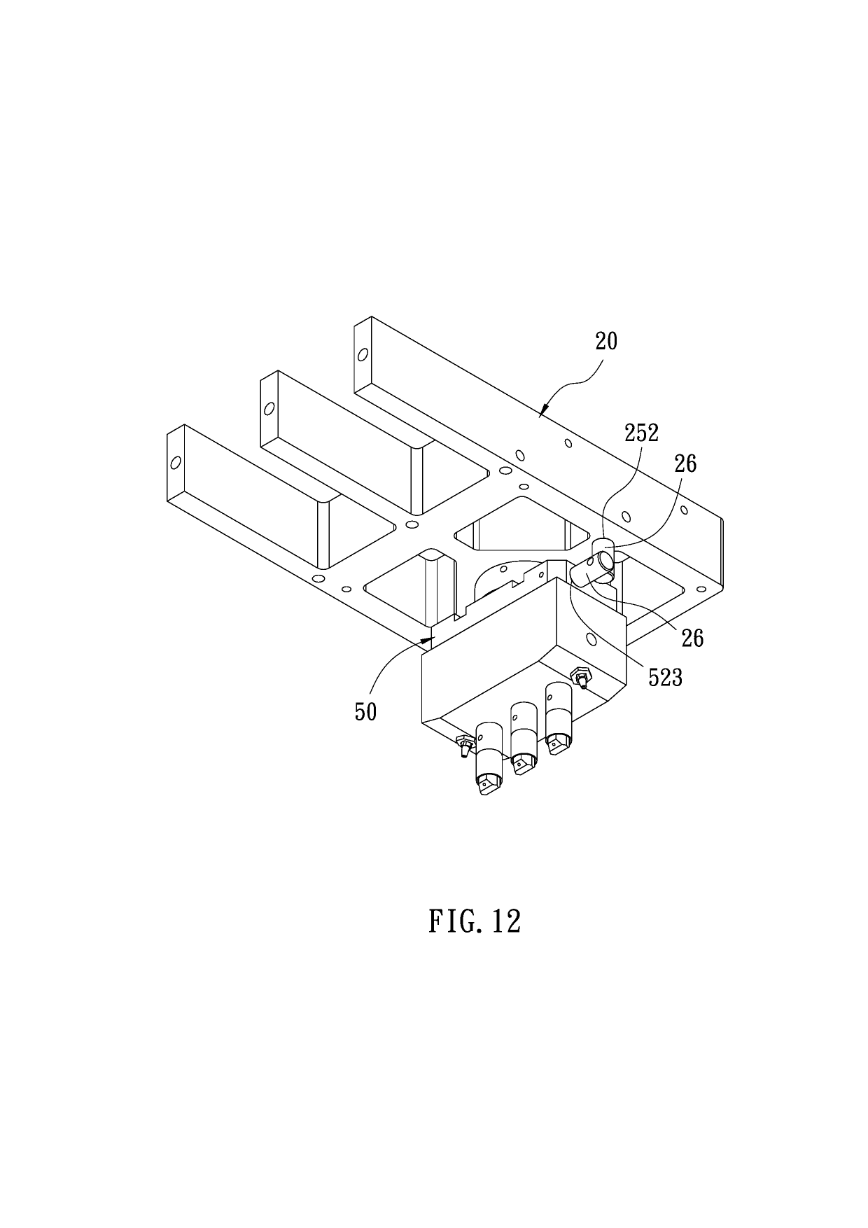

It is noted that the rotatable dust-removal device of the present invention are also configured in a non-rotating mode, where the cleaner head is fixed. As shown in the previously described embodiments, before operation, the non-rotating configuration is achieved by first removing the two jet heads 255 from the diversion ports 252 (as shown in FIG. 4), and then removing the plug 524 from the machining hole 523 of the rotatable connection seat 50. Next, a plurality of locking elements 26 (e.g., pins or bolts) are respectively fixed to the diversion ports 252 on the positioning base 20 and the machining hole 523 of the rotatable connection seat 50. This causes the two locking elements 26 to interlock in longitudinal and transverse directions, thus creating a mutually restrictive state. Through the use of the two locking elements 26, the positioning base 20 and the rotatable connection seat 50 are effectively restricted in movement, thus preventing rotation of the rotatable connection seat 50 relative to the positioning base 20. As illustrated in FIGS. 11 and 12, this achieves a fixed, non-rotating configuration of the cleaner head.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A rotatable dust removal device configured to perform a cleaning operation on a workpiece, comprising:
an outer housing having a receiving space defined by a surrounding wall and opened at a bottom of the outer housing, and at least two inflow orifices and at least one outflow orifice located at a top of the surrounding wall; and
at least one cleaner head disposed within the outer housing, the at least one cleaner head including a positioning base, a central shaft, a rotatable connection seat, a body, and a plurality of air nozzles;
wherein the positioning base includes at least one vent port communicating with one of the at least two inflow orifices, two injection ports respectively communicating with the other of the at least two inflow orifices, and two air guiding channels respectively communicating with the two injection ports;
wherein the central shaft includes an axial hole extending along an axis and communicating with the at least one vent port;
wherein the rotatable connection seat is rotatably mounted on the central shaft and disposed below the positioning base, the rotatable connection seat including a through hole through which the central shaft extends, and two swirling channels respectively communicating with the two air guiding channels, wherein each swirling channel has an outlet;
wherein the body is connected to the rotatable connection seat and rotatably mounted at a bottom of the central shaft, the body cooperating with the surrounding wall of the outer housing to define a dust collection channel communicating with the at least one outflow orifice, the body including a central hole coaxially aligned with the axis, a plurality of through holes located at a bottom of the body and respectively communicating with the central hole, and an airflow passage formed by the axial hole and the through holes; and
wherein the plurality of air nozzles are respectively connected to the plurality of through holes of the body, each injector including a spray tube and a nozzle, the nozzle has at least one spray orifice communicating with the dust collection channel;
wherein when the rotational airflow is pumped from the two air guiding channels into the two swirling channels and ejected from the outlets of the two swirling channels, a rotational torque is generated to drive the rotatable connection seat, the body, and the plurality of air nozzles to rotate synchronously around the central shaft.

2. The rotatable dust removal device as claimed in claim 1, wherein the surrounding wall of the outer housing has a casing defining the receiving space, and a top lid closed to a top of the casing, and wherein the at least two inflow orifices and the at least one outflow orifice are defined on the top lid.

3. The rotatable dust removal device as claimed in claim 1, wherein the positioning base further includes a reinforcement plate, the reinforcement plate is connected between a bottom of the positioning base and the outer housing.

4. The rotatable dust removal device as claimed in claim 1, wherein the plurality of through holes of the body are arranged in a spaced manner at the bottom of the body, wherein a centrally located through hole is vertically oriented, and wherein two side through holes are outwardly inclined.

5. The rotatable dust removal device as claimed in claim 1, wherein the at least one cleaner head further includes two wing plates respectively mounted on a top of the rotatable connection seat, each of the two wing plates has at least one concave arc portion formed on an outer side thereof, wherein each of the two air guiding channels is provided with two diversion ports located on a bottom of the positioning base, and wherein rotational airflow introduced from an outer diversion port is configured to be sprayed toward the concave arc portion of the wing plate, thus driving the two wing plates to rotate and simultaneously causing the rotatable connection seat, the body, and the plurality of air nozzles to rotate.

6. The rotatable dust removal device as claimed in claim 5, wherein the at least one cleaner head further comprises a plurality of jet heads, each of the plurality of jet heads is connected to a respective outer diversion port defined on the two air guiding channels of the positioning base.

7. The rotatable dust removal device as claimed in claim 1 further comprising a plurality of air inlets for introducing external airflow, each of the plurality of air inlets is connected to a corresponding injection port of the positioning base.

8. The rotatable dust removal device as claimed in claim 1, wherein the at least one cleaner head further includes an air guiding seat connected between the positioning base and the rotatable connection seat, the air guiding seat has an upper shell and a lower shell that are connected together to define an air chamber; the upper shell includes a mounting portion secured to the at least one vent port of the positioning base, and a plurality of upper guiding holes arranged around an outer wall of the mounting portion of the upper shell; the central shaft extends through the upper and lower shells, and an upper end of the central shaft is fixedly connected to the upper shell; the lower shell is fixed to a top of the rotatable connection seat and includes a plurality of lower guiding holes corresponding to the upper guiding holes of the upper shell; the air guiding seat communicates with the two swirling channels of the rotatable connection seat via the plurality of lower guiding holes of the lower shell.

9. The rotatable dust removal device as claimed in claim 1, wherein the two outlets of the two swirling channels of the rotatable connection seat are defined on two opposite outer walls of the rotatable connection seat at a 180-degree angle relative to each other.

10. The rotatable dust removal device as claimed in claim 1 further comprising a bearing assembly disposed between the central hole of the body and an outer wall of the central shaft, such that the body is rotatable about the central shaft.

11. The rotatable dust removal device as claimed in claim 1 further comprising at least one collection hood, wherein the at least one collection hood is fixed to a bottom of the positioning base and surrounds the body.

12. The rotatable dust removal device as claimed in claim 1 further comprising an inner cover, wherein the inner cover is a hollow shell disposed above and covering the at least one vent port of the positioning base.

13. The rotatable dust removal device as claimed in claim 1 further comprising at least one air joint configured to introduce external airflow, wherein the at least one air joint is connected to one of the at least two inflow orifices of the outer housing.

14. The rotatable dust removal device as claimed in claim 13, wherein a plurality of air joints are provided, and a plurality of inflow orifices of the outer housing are provided.

15. The rotatable dust removal device as claimed in claim 1, wherein the spray tube includes a through passage in communication with the through hole of the body, and at least one flow guide element transversely disposed through the through passage, wherein a diameter of the through passage is greater than a diameter of the flow guide element, and an outer wall of the flow guide element is arcuate.

16. The rotatable dust removal device as claimed in claim 1, wherein the spray tube includes a mounting portion at a top end and a connecting portion at a bottom end, wherein the mounting portion of the spray tube is connected to the through hole of the body, and a mounting portion is formed at a top of the nozzle and connected to the connecting portion of the spray tube.

17. The rotatable dust removal device as claimed in claim 16, wherein a front end of the nozzle is formed in a conical tip shape.

18. The rotatable dust removal device as claimed in claim 16, wherein a front end of the nozzle is formed in a flat surface shape.

19. The rotatable dust removal device as claimed in claim 1, wherein the rotatable dust removal device comprises multiple cleaner heads and a plurality of collection hoods, wherein the multiple cleaner heads are positioned and connected by using a single horizontally extended positioning base, and the plurality of collection hoods are disposed at a bottom of the positioning base and respectively surround the bodies of the multiple cleaner heads.
